(19) United States
(12) Patent Application Publication
(10) Pub. No.: US 2018/0308282 A1
(43) Pub. Date: Oct. 25, 2018

(54) SHAPE MEASURING APPARATUS AND METHOD

(71) Applicant: DENSO CORPORATION, Kariya-city (JP)

(72) Inventor: Kensuke YOKOI, Kariya-city (JP)

(21) Appl. No.: 15/956,215

(22) Filed: Apr. 18, 2018

(30) Foreign Application Priority Data
Apr. 20, 2017 (JP) 2017-083782

(51) Int. Cl. G06T 17/05; H04N 7/18; G06T 7/60; G06T 7/593

(52) U.S. Cl. CPC G06T 17/05; G06T 7/593; G06T 7/60; H04N 7/181

(57) ABSTRACT

In a shape measuring apparatus, an image processing unit derives, based on a calculated disparity, absolute distance information about a first imaging target located in a common image region from a shape measuring apparatus. The image processing unit reconstructs a 3D shape of each of imaging subjects including the first and second imaging subjects based on the sequential monochrome images.

### CROSS REFERENCE TO RELATED APPLICATION

This application is based on and claims the benefit of priority from Japanese Patent Application No. 2017-083782 filed on Apr. 20, 2017, the disclosure of which is incorporated in its entirety herein by reference.

### TECHNICAL FIELD

The present disclosure relates to shape measuring apparatuses and methods.

### BACKGROUND

Japanese Patent Application Publication No. 2015-219212, which will be referred to as a published patent document, discloses a distance measuring apparatus comprised of a stereo camera system; the stereo camera system includes a color imaging device and a monochrome imaging device.

The stereo camera system is configured to acquire a monochrome image and a color image of an imaging subject respectively captured by the monochrome imaging device and the color imaging device arranged to be close to each other with a predetermined interval therebetween. Then, the stereo camera system is configured to perform stereo-matching of the captured monochrome and color images to thereby measure the distance from the stereo camera system to the imaging subject.

In particular, monochrome images captured by such a monochrome imaging device have higher resolution than color images captured by such a color imaging device. Monochrome images of an imaging subject therefore enable the shape of the imaging subject to be recognized with higher accuracy.

In contrast, color images of an imaging subject captured by such a color imaging device include color information about the imaging subject. Color images of a specific imaging subject that is recognizable based on only their color information enable the specific imaging subject to be recognized

That is, the stereo camera system including the color imaging device and the monochrome imaging device obtains both advantages based on monochrome images and advantages based on color images.

### SUMMARY

Using a wide-angle camera having a relatively wide angle of view as an in-vehicle imaging device is advantageous to recognize imaging subjects located in a relatively wide region, such as an intersection. In contrast, using a narrow-angle camera having a relatively narrow angle of view as an in-vehicle imaging device is advantageous to recognize imaging subjects, such as traffic lights or vehicles, located at long distances from the narrow-angle camera. This is because an image of such a long-distance imaging subject captured by the narrow-angle camera includes a higher percentage of the region of the long-distance target to the total region of the image.

From these viewpoints, the inventor of the present application has considered distance measuring apparatuses, each of which has both the advantages based on the combined use of monochrome and color images and the advantages based on the combined use of wide- and narrow-angles of view.

That is, one aspect of the present disclosure seeks to provide shape measuring apparatuses and methods, each of which is capable of making effective use of the first features of monochrome and color images and the second features of wide- and narrow-angles of view.

According to a first exemplary aspect of the present disclosure, there is provided a shape measuring apparatus. The shape measuring apparatus includes a first imaging device having a first field of view defined based on a first view angle. The first imaging device is configured to capture sequential monochrome images based on the first field of view. The shape measuring apparatus includes a second imaging device having a second field of view defined based on a second view angle. The second imaging device is configured to capture a color image based on the second field of view, the second view angle being narrower than the first view angle. The first and second fields of view have a common field of view. The shape measuring apparatus includes an image processing unit configured to

(1) Calculate a disparity between a common image region of a selected one of the monochrome images and the color image, the selected monochrome image being substantially synchronized with the color image, the common image region having a field of view that is common to the second field of view of the second imaging device, the imaging subjects including at least a first imaging subject located in the common image region and a second imaging subject located at least partly outside the common image region

(2) Derive, based on the calculated disparity, absolute distance information about the first imaging target from the shape measuring apparatus

(3) Reconstruct a three-dimensional shape of each of the imaging subjects including the first and second imaging subjects based on the sequential monochrome images

According to a second exemplary aspect of the present disclosure, there is provided a shape measuring method. The shape measuring method includes

(1) Capturing, using a first imaging device having a first field of view defined based on a first view angle, sequential monochrome images based on the first field of view

(2) Capturing, using a second imaging device having a second field of view defined based on a second view angle, a color image based on the second field of view, the second view angle being narrower than the first view angle, the first and second fields of view having a common field of view

(3) Calculating a disparity between a common image region of a selected one of the monochrome images and the color image, the selected monochrome image being substantially synchronized with the color image, the common image region having a field of view that is common to the second field of view of the second imaging device, the imaging subjects including at least a first imaging subject located in the common image region and a second imaging subject located at least partly outside the common image region

(4) Deriving, based on the calculated disparity, absolute distance information about the first imaging target from a predetermined reference point

(5) Reconstructing a three-dimensional shape of each of the imaging subjects including the first and second imaging subjects based on the sequential monochrome images

Each of the shape measuring apparatus and method according to the first and second exemplary aspects is configured to make effective use of the first features of monochrome and color images and the second features of the first view angle and the second view angle narrower than the first view angle.

That is, each of the shape measuring apparatus and method is configured to derive, from the sequential monochrome images, a 3D shape of each of the first and second imaging subjects in each of the sequential monochrome images. This configuration enables the 3D shape of each of the imaging subjects, which cannot be recognized by stereo-matching between a monochrome image and a color image, to be recognized.

Each of the shape measuring apparatus and method also enables the 3D shape of the second imaging subject located at least partly outside the common image region to be obtained in accordance with the reference of the absolute distance of the first imaging subject located in the common image region.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the overall structure of a shape measuring apparatus according to a present embodiment of the present disclosure;

FIG. 2 is a view schematically illustrating how a shape measuring apparatus is arranged, and illustrating a first field of view of a monochrome camera and a second field of view of a color camera illustrated in FIG. 1;

FIG. 3 is a view schematically illustrating how a rolling shutter mode is carried out;

FIG. 4A is a diagram schematically illustrating an example of a wide-angle monochrome image;

FIG. 4B is a diagram schematically illustrating an example of a narrow-angle color image;

FIG. 5 is a flowchart schematically illustrating an example of a shape measurement task according to the present embodiment;

FIG. 6 is a flowchart schematically illustrating an image recognition task according to the present embodiment; and

FIG. 7 is a view schematically illustrating how the image recognition task is carried out.

### DETAILED DESCRIPTION OF EMBODIMENT

The following describes a present embodiment of the present disclosure with reference to the accompanying drawings. The present disclosure is not limited to the following present embodiment, and can be modified.

### Descriptions of Structure of Shape Measuring Apparatus

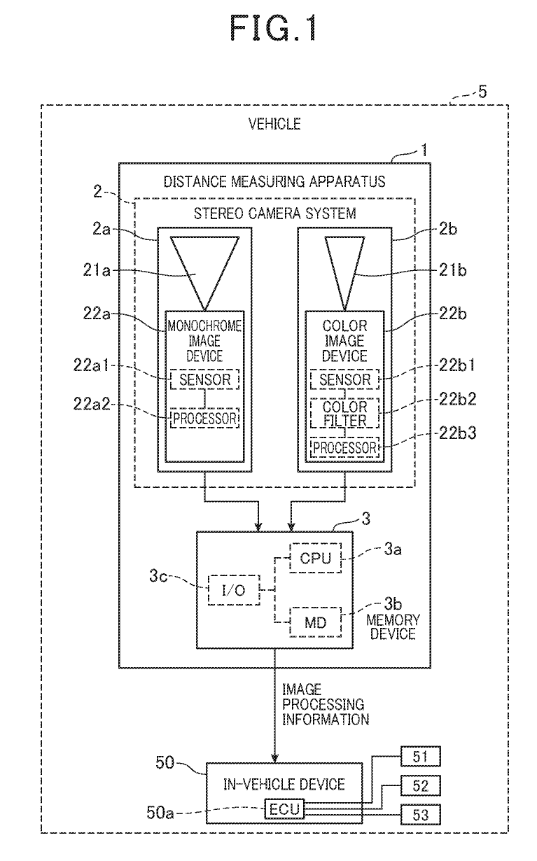

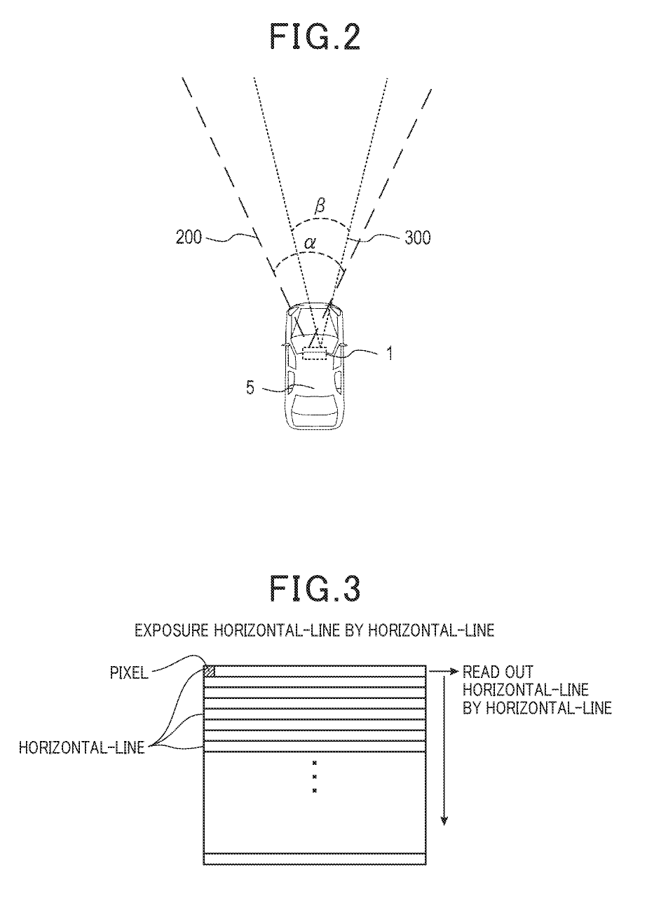

The following describes an example of the structure of a shape measuring apparatus 1 installable in a vehicle according to the present embodiment of the present disclosure with reference to FIGS. 1 and 2.

Referring to FIG. 1, the shape measuring apparatus 1, which is installed in a vehicle 5, includes a stereo camera system 2 and an image processing unit 3. For example, the shape measuring apparatus 1 is encapsulated as a package. The packaged shape measuring apparatus 1 is for example mounted within the passenger compartment of the vehicle 5 such that the apparatus 1 is mounted to the inner surface of a front windshield W and close to the center of a front windshield mirror (not shown).

Referring to FIG. 2, the shape measuring apparatus 1 has measurement regions in front of the vehicle 5, and is operative to measure distance information about imaging subjects located within at least one of the measurement regions.

The stereo camera system 2 is comprised of a pair of monochrome camera 2a and a color camera 2b. The monochrome camera 2a captures monochrome images in front of the vehicle 5, and the color camera 2b captures color images in front of the vehicle 5.

The monochrome camera 2a has a predetermined first angle of view, i.e. a first view angle, α in, for example, the width direction of the vehicle 5, and the color camera 2b has a predetermined second angle of view, i.e. a second view angle, β in, for example, the width direction of the vehicle 5. The first view angle, referred to as a first horizontal view angle, α of the monochrome camera 2a is set to be wider than the second view angle, referred to as a second horizontal view angle, β of the color camera 2b. This enables a monochrome image having a wider view angle and a color image having a narrower view angle to be obtained.

A first vertical view angle of the monochrome camera 2a in the vertical direction, i.e. the height direction, of the vehicle 5 can be set to be equal to a second vertical view angle of the color image camera 2b.

In addition, the monochrome camera 2a can have a predetermined first diagonal view angle in a diagonal direction corresponding to a diagonal direction of a captured monochrome image, and the color camera 2b can have a predetermined second diagonal view angle in a diagonal direction corresponding to a diagonal direction of a captured color image. The first diagonal view angle of the monochrome camera 2a can be set to be wider than the second diagonal view angle of the color camera 2b.

For example, the monochrome camera 2a and the color camera 2b are arranged parallel to the width direction of the vehicle 5 to substantially have the same height and to have a predetermined interval therebetween. The monochrome camera 2a and the color camera 2b are arranged to be symmetric with respect to a center axis of the vehicle 5; the center axis of the vehicle 5 has the same height as the height of each of the cameras 2a and 2b and passes through the center of the vehicle 5 in the width direction of the vehicle 5. The center of the monochrome camera 2a and the color camera 2b in the vehicle width direction serves as, for example, a reference point.

For example, as illustrated in FIG. 2, the monochrome camera 2a is located on the left side of the center axis when viewed from the rear to the front of the vehicle 5, and the color camera 2b is located on the right side of the center axis when viewed from the rear to the front of the vehicle 5.

That is, the monochrome camera 2a has a first field of view (FOV) 200 defined based on the first horizontal view angle α and the first vertical view angle, and the color camera 2b has a second field of view 300 defined based on the second horizontal view angle β and the second vertical view angle. The first field of view 200 and the second field of view 300 have a common field of view. That is, an overlapped area between the first field of view 200 and the second field of view 300 constitutes the common field of view.

For example, the almost second field of view 300 is included in the first field of view 200, so that a part of the second field of view 300 contained in the first field of view 200 constitutes the common field of view between the first field of view 200 and the second field of view 300.

The above arrangement of the monochrome camera 2a and the color camera 2b enables, if a monochrome image of an imaging subject is captured by the monochrome camera 2a and a color image of the same imaging subject is captured by the color camera 2b, a disparity between two corresponding points between the monochrome image and the color image to be provided.

That is, each of the monochrome camera 2a and the color camera 2b is configured to capture a frame image having a predetermined size based on the corresponding one of the first and second field of views 200 and 300 in a predetermined same period. Then, the monochrome camera 2a and the color camera 2b are configured to output, in the predetermined period, monochrome image data based on the frame image captured by the monochrome camera 2a and color image data based on the frame image captured by the color camera 2b to the image processing unit 3. That is, the monochrome camera 2a and the color camera 2b generate and output monochrome image data and color image data showing a pair of a left frame image and a right frame image including a common region to the image processing unit 3 for each of predetermined same timings.

For example, as illustrated in FIG. 1, the monochrome camera 2a is comprised of a wide-angle optical system 21a and a monochrome imaging device 22a. The monochrome imaging device 22a includes an image sensor (SENSOR in FIG. 1) 22a1 and a signal processor or a processor (PROCESSOR in FIG. 1) 22a2. The image sensor 22a1, such as a CCD image sensor or a CMOS image sensor, is comprised of light-sensitive elements each including a CCD device or CMOS switch; the light-sensitive elements serve as pixels and are arranged in a two-dimensional array. That is, the array of the pixels is configured as a predetermined number of vertical columns by a predetermined number of horizontal rows. The two-dimensionally arranged pixels constitute an imaging area, i.e. a light receiving area.

The wide-angle optical system 21a has the first horizontal view angle α set forth above, and causes light incident to the monochrome camera 2a to be focused, i.e. imaged, on the light receiving area of the image sensor 22a1 as a frame image.

The signal processor 22a2 is configured to perform a capturing task that causes the two-dimensionally arranged right sensitive elements to be exposed to light incident to the imaging area during a shutter time, i.e. an exposure time or at a shutter speed, so that each of the two-dimensionally arranged light-sensitive elements (pixels) receives a corresponding component of the incident light. Each of the two-dimensionally arranged light-sensitive elements is also configured to convert the intensity or luminance level of the received light component into an analog pixel value or an analog pixel signal, i.e. an analog pixel voltage signal, that is proportional to the luminance level of the received light component, thus forming a frame image.

As described above, the monochrome imaging device 22a does not include a color filter on the light receiving surface of the image sensor 22a1. This configuration eliminates the need to perform a known demosaicing process that interpolates, for each pixel of the image captured by the light receiving surface of the image sensor 22a1, missing colors into the corresponding pixel. This makes it possible to obtain monochrome frame images having higher resolution than color images captured by image sensors with color filters. Hereinafter, frame images captured by the monochrome camera 2a will also be referred to as wide-angle monochrome images.

Note that a wide-angle monochrome image, i.e. a frame image, captured by the monochrome camera 2a can be converted into a digital wide-angle monochrome image comprised of digital pixel values respectively corresponding to the analog pixel values, and thereafter output to the image processing unit 3. Alternatively, a wide-angle monochrome image, i.e. a frame image, captured by the monochrome camera 2a can be output to the image processing unit 3, and thereafter, the wide-angle monochrome image can be converted by the image processing unit 3 into a digital wide-angle monochrome image comprised of digital pixel values respectively corresponding to the analog pixel values.

For example, as illustrated in FIG. 1, the color camera 2b is comprised of a narrow-angle optical system 21b and a color imaging device 22b. The color imaging device 22b includes an image sensor (SENSOR in FIG. 1) 22b1, a color filter (FILTER in FIG. 1) 22b2, and a signal processor or a processor (PROCESSOR in FIG. 1) 22b3. The image sensor 22b1, such as a CCD image sensor or a CMOS image sensor, is comprised of light-sensitive elements each including a CCD device or CMOS switch; the light-sensitive elements serve as pixels and are arranged in a two-dimensional array. That is, the array of the pixels is configured as a predetermined number of columns by a predetermined number of rows. The two-dimensionally arranged pixels constitute an imaging area, i.e. a light receiving area.

The color filter 22b2 includes a Bayer color filter array comprised of red (R), green (G), and blue (B) color filter elements arrayed in a predetermined Bayer arrangement; the color filter elements face the respective pixels of the light receiving surface of the image sensor 22b1.

The narrow-angle optical system 21b has the second horizontal view angle β set forth above, and causes light incident to the color camera 2b to be focused, i.e. imaged, on the light receiving area of the image sensor 22b1 via the color filter 22b2 as a frame image.

The signal processor 22b3 is configured to perform a capturing task that causes the two-dimensionally arranged right sensitive elements to be exposed to light incident to the imaging area during a shutter time, i.e. an exposure time or at a shutter speed, so that each of the two-dimensionally arranged light-sensitive elements (pixels) receives a corresponding component of the incident light. Each of the two-dimensionally arranged light-sensitive elements is also configured to convert the intensity or luminance level of the received light component into an analog pixel value or an analog pixel signal, i.e. an analog pixel voltage signal, that is proportional to the luminance level of the received light component, thus forming a frame image.

As described above, the color imaging device 22b includes the color filter 22b2, which is comprised of the RGB color filter elements arrayed in the predetermined Bayer arrangement, on the light receiving surface of the image sensor 22b1. For this reason, each pixel of the frame image captured by the image sensor 22b1 has color information indicative of a monochronic color matching with the color of the corresponding color filter element of the color filter 22b2.

In particular, the signal processor 22b3 of the color imaging device 22b is configured to perform the demosaicing process that interpolates, for each pixel of the image, i.e. the raw image, captured by the light receiving surface of the image sensor 22b1, missing colors into the corresponding pixel, thus obtaining a color frame image of an imaging subject; the color frame image reproduces colors that are similar to the original natural colors of the imaging subject.

Color frame images captured by the color image sensor 22b1 of the color camera 22b set forth above usually have lower resolution than monochrome images captured by monochrome cameras each having a monochrome image sensor whose imaging area has the same size as the imaging area of the color image sensor 22b1.

Hereinafter, frame images captured by the color camera 2b will also be referred to as narrow-angle color images.

Note that a narrow-angle color image, i.e. a frame image, captured by the color camera 2b can be converted into a digital narrow-angle color image comprised of digital pixel values respectively corresponding to the analog pixel values, and thereafter output to the image processing unit 3. Alternatively, a narrow-angle color image, i.e. a frame image, captured by the color camera 2b can be output to the image processing unit 3, and thereafter, the narrow-angle color image can be converted by the image processing unit 3 into a digital narrow-angle color image comprised of digital pixel values respectively corresponding to the analog pixel values.

In particular, the signal processor 22a2 of the monochrome camera 2a is configured to

(1) Cause the light receiving area (see FIG. 3) of the image sensor 22a1 to be exposed to incident light horizontal-line (row) by horizontal-line (row) from the top horizontal low to the bottom horizontal row in a known rolling shutter mode

(2) Convert, horizontal-line by horizontal-line, the intensity or luminance levels of the received light components of each horizontal line into analog pixel values of the corresponding horizontal line

(3) Read out, horizontal-line by horizontal-line, the analog pixel values of each of the horizontal line

(4) Combine the analog pixel values of the respective horizontal lines with each other to thereby obtain a frame image

Similarly, the signal processor 22b3 of the color camera 2b is configured to

(1) Cause the light receiving area of the image sensor 22b1 to be exposed to incident light horizontal-line (row) by horizontal-line (row) from the top horizontal low to the bottom horizontal row in the known rolling shutter mode

(2) Convert, horizontal-line by horizontal-line, the intensity or luminance levels of the received light components of each horizontal line into analog pixel values of the corresponding horizontal line

(3) Read out, horizontal-line by horizontal-line, the analog pixel values of each of the horizontal line

(4) Combine the analog pixel values of the respective horizontal lines with each other to thereby obtain a frame image

As illustrated in FIG. 2, the monochrome camera 2a and the color camera 2b are arranged such that the first field of view 200 of the monochrome camera 2a and the second field of view 300 of the color camera 2b are partly overlapped each other; the overlapped area constitutes the common field of view.

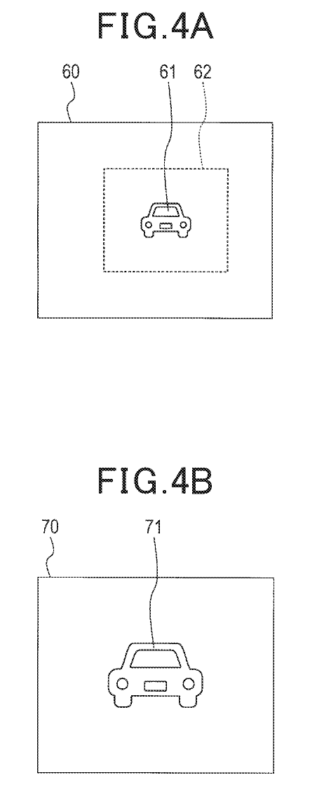

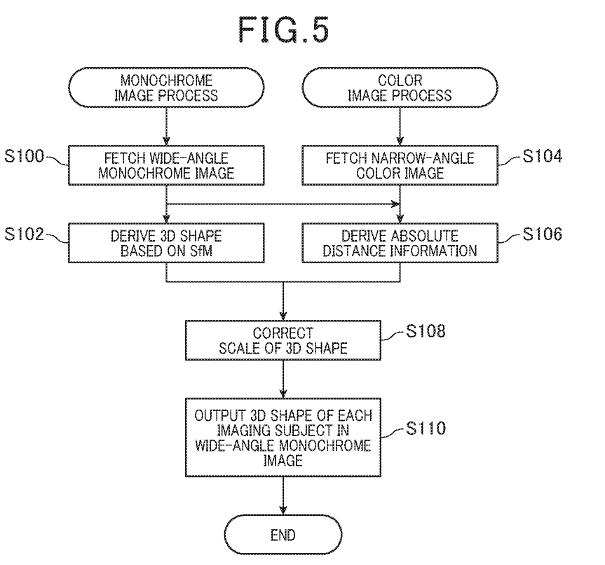

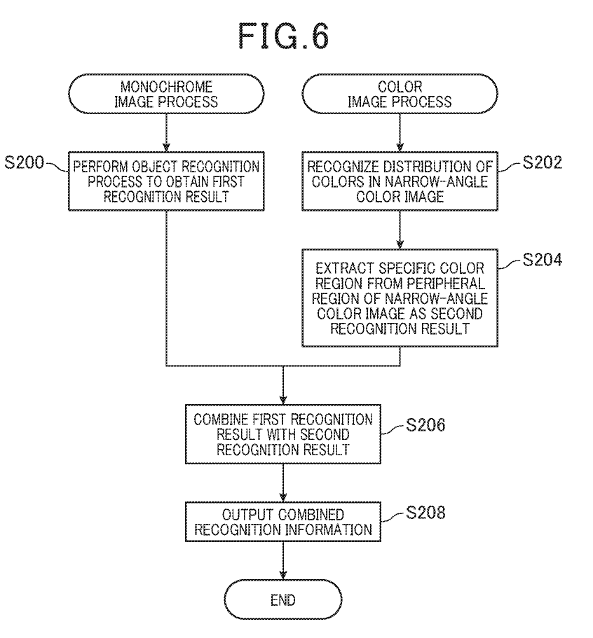

FIG. 4A illustrates an example of a wide-angle monochrome image 60 of a scene in front of the vehicle 5 captured by the monochrome camera 2a based on the first field of view 200, and FIG. 4B illustrates an example of a narrow-angle color image 70 of a scene in front of the vehicle 5 captured by the color camera 2b based on the second field of view 300. The narrow-angle color image 70 actually contains color information about the captured scene. Reference numeral 62 shows, in the wide-angle monochrome image 60, a common-FOV image region whose field of view is common to the second field of view 300 of the narrow-angle color image 70. Note that the dashed rectangular region to which reference numeral 62 is assigned merely shows the common FOV image region whose field of view is common to the second field of view 300 of the narrow-angle color image 70, and does not show an actual edge in the wide-angle monochrome image 60.

The wide-angle monochrome image 60 includes an image 61 of a preceding vehicle as an imaging subject; the preceding vehicle is located in the common field of view. The narrow-angle color image 70 also includes an image 71 of the same preceding vehicle as the same imaging subject. If the size of the light receiving area of the image sensor 22a1 is identical to the size of the light receiving area of the image sensor 22b1, the image 61 of the preceding vehicle included in the wide-angle monochrome image 60 is smaller than the image 71 of the preceding vehicle included in the narrow-angle monochrome image 70 by the ratio of the first horizontal view angle α to the second horizontal view angle β. This is because the first field of view 200 is greater than the second field of view 300.

Stereo-matching for the wide-angle monochrome image 60 and the narrow-angle color image 70 is specially configured to calculate a disparity between each point of the common-FOV image region 62 of the wide-angle monochrome image 60 and a corresponding point of the narrow-angle color image 70; the common-FOV image region 62 has a field of view that is common to the second field of view 300 of the narrow-angle color image 70.

Note that, as a precondition to the execution of the stereo-matching, predetermined intrinsic and extrinsic parameters of the monochrome camera 2a and corresponding intrinsic and extrinsic parameters of the color camera 2b have been strictly calibrated, so that the coordinates of each point, such as each pixel, in the wide-angle monochrome image 60 accurately correlate with the coordinates of the corresponding point in the narrow-angle color image 70, and the coordinates of each point, such as each pixel, in the common-FOV image region 62 whose field of view is common to the second field of view 300 of the narrow-angle color image 70, have been obtained.

If an exposure period for the common-FOV image region 62 of the wide-angle monochrome image 60 captured by the monochrome camera 2a in the rolling shutter mode does not match with an exposure period for the narrow-angle color image 70 captured by the color camera 2b in the rolling shutter mode, the image 61 of the imaging subject included in the common-FOV image region 62 of the wide-angle monochrome image 60 is different from the image 71 of the imaging subject included in the narrow-angle color image 70 due to the time difference between the exposure period for the common-FOV image region 62 and the exposure period for the narrow-angle color image 70.

This might result in errors in the distance information obtained based on the disparity between each point of the common-FOV image region 62 of the wide-angle monochrome image 60 and a corresponding point of the narrow-angle color image 70.

Note that the exposure period for an image region is defined as a period from the start of exposure of the image region in the rolling shutter mode to light to the completion of the exposure of the image region to light.

From this viewpoint, for matching the exposure period of the common-FOV image region 62 of the wide-angle monochrome image 60 with the exposure period of the whole of the narrow-angle color image 70, at least one of the monochrome imaging device 22a and the color imaging device 22b is designed to change at least one of a first exposure time and a second exposure time relative to the other thereof.

The first exposure interval represents an interval between the end of the exposure of one horizontal line (row) to incident light and the start of the exposure of the next horizontal line to incident light for the wide-angle monochrome image 60.

The second exposure interval represents an interval between the end of the exposure of one horizontal line to incident light and the start of the exposure of the next horizontal line to incident light for the narrow-angle color image 70. This exposure-interval changing aims to substantially synchronize the exposure period of the common-FOV image region 62 of the wide-angle monochrome image 60 with the exposure period of the whole of the narrow-angle color image 70.

Specifically, it is assumed that the number of horizontal lines (rows) of the image sensor 22a1 of the monochrome camera 2a is set to be equal to the number of horizontal lines (rows) of the image sensor 22b1 of the color camera 2b.

In this assumption, the ratio of the exposure interval between the horizontal lines including all pixels of the common-FOV image region 62 to the exposure interval between the horizontal lines of the narrow-angle color image 70 can be determined based on the ratio of the number of the horizontal lines including all pixels of the common-FOV image region 62 to the number of the horizontal lines of the narrow-angle color image 70. That is, the exposure intervals between the horizontal lines of the wide-angle monochrome image 60 including the common-FOV image region 62 are set to be relatively longer based on the ratio of the first horizontal view angle α to the second horizontal view angle β than the exposure intervals between the horizontal lines of the narrow-angle monochrome image 70. This makes it possible to synchronize the exposure period of the common-FOV image region 62 with the exposure period of the narrow-angle monochrome image 70.

Alternatively, the exposure intervals between the horizontal lines of the narrow-angle monochrome image 70 are set to be relatively shorter based on the ratio of the first horizontal view angle α to the second horizontal view angle β than the exposure intervals between the horizontal lines of the wide-angle monochrome image 60 including the common-FOV image region 62. This also makes it possible to synchronize the exposure period of the common-FOV image region 62 with the exposure period of the narrow-angle monochrome image 70.

Returning to FIG. 1, the image processing unit 3 is designed as an information processing unit including a CPU 3a, a memory device 3b including, for example, at least one of a RAM, a ROM, and a flash memory, and an input-output (I/O) interface 3c, or other peripherals; the CPU 3a, memory device 3b, I/O, and peripherals are communicably connected to each other. The semiconductor memory is an example of a non-transitory storage medium.

For example, a microcontroller or a microcomputer in which functions of a computer system have been collectively installed embodies the image processing unit 3. For example, the CPU 3a of the image processing unit 3 executes at least one program stored in the memory device 3b, thus implementing functions of the image processing unit 3. Similarly, the functions of the image processing unit 3 can be implemented by at least one hardware unit. A plurality of microcontrollers or microcomputers can embody the image processing unit 3.

That is, the memory device 3b serves as a storage in which the at least one program is stored, and also serves as a working memory in which the CPU 3a performs various recognition tasks.

The CPU 3a of the image processing unit 3 receives a wide-angle monochrome image captured by the monochrome camera 2a and output therefrom, and a narrow-angle color image captured by the color camera 2b and output therefrom. The CPU 3a stores the pair of the wide-angle monochrome image, i.e. a left image, and the narrow-angle color image, i.e. a right image, in the memory device 3b. Then, the CPU 3a performs the image processing tasks, which include a shape measurement task and an image recognition task, based on the wide-angle monochrome image and the narrow-angle color image in the memory device 3b to thereby obtain image processing information about at least one imaging subject included in each of the wide-angle monochrome image and narrow-angle color image. The image processing information about the at least one imaging subject includes

(1) Distance information to the at least one imaging subject relative to the stereo camera 2

(2) Image recognition information indicative of the at least one imaging subject

Then, the CPU 3a outputs the image processing information about the at least one imaging subject to predetermined in-vehicle devices 50 including, for example, an ECU 50a for mitigating and/or avoiding collision damage between the vehicle 5 and the at least one imaging subject in front of the vehicle 5.

Specifically, the ECU 50a is configured to

(1) Determine whether the vehicle 5 will collide with the at least one imaging subject in accordance with the image recognition information

(2) Perform avoidance of the collision and/or mitigation of damage based on the collision using, for example, a warning device 51, a brake device 52, and/or a steering device 53.

The warning device 51 includes a speaker and/or a display mounted in the compartment of the vehicle 5. The warning device 51 is configured to output warnings including, for example, warning sounds and/or warning messages to inform the driver of the presence of the at least one imaging subject in response to a control instruction sent from the ECU 50a.

The brake device 52 is configured to brake the vehicle 5. The brake device 52 is activated in response to a control instruction sent from the ECU 50a when the ECU 50a determines that there is a high possibility of collision of the vehicle 5 with the at least one object.

The steering device 53 is configured to control the travelling course of the vehicle 5. The steering device 53 is activated in response to a control instruction sent from the ECU 50a when the ECU 50a determines that there is a high possibility of collision of the vehicle 5 with the at least one imaging subject.

Next, the following describes the shape measurement task carried out by the CPU 3a of the image processing unit 3 in a predetermined first control period.

In step S100 of a current cycle of the shape measurement task, the CPU 3a fetches a wide-angle monochrome image each time the monochrome camera 2a captures the wide-angle monochrome image, and loads the wide-angle monochrome image into the memory device 3b. This therefore results in the wide-angle monochrome images including the wide-angle monochrome image fetched in the current cycle and the wide-angle monochrome images fetched in the previous cycles having been stored in the memory device 3b. Note that the wide-angle monochrome image fetched in the current cycle will be referred to as a current wide-angle monochrome image, and the wide-angle monochrome images fetched in the previous cycles will be referred to as previous wide-angle monochrome images.

Next, the CPU 3a derives, from the sequentially fetched wide-angle monochrome images including the current wide-angle monochrome image and the previous wide-angle monochrome images, the three-dimensional shape of each of imaging subjects included in the sequentially fetched wide-angle monochrome images in step S102.

Specifically, in step S102, the CPU 3a derives, from the sequential wide-angle monochrome images, the three-dimensional (3D) shape of each of the imaging subjects using, for example, a known structure from motion (SfM) approach. The SfM approach is to obtain corresponding feature points in the sequential wide-angle monochrome images, and to reconstruct, based on the corresponding feature points, the 3D shape of each of the imaging subjects in the memory device 2b. The reconstructed 3D shape of each of the imaging subjects based on the SfM approach has scale invariance, so that the relative relationships between the corresponding feature points are reconstructed, but the absolute scale of each of the imaging subjects cannot be reconstructed.

In step S104, the CPU 3a fetches a current narrow-angle color image that has been captured by the color camera 2b in synchronization with the current wide-angle monochrome image, from the color camera 2b, and loads the narrow-angle color image into the memory device 3b.

In step S106, the CPU 3a derives, relative to the stereo camera 2, distance information to at least one imaging subject located in the common-FOV image region, referred to as at least one common-FOV imaging subject, in the imaging subjects using stereo-matching based on the current wide-angle monochrome image and the current narrow-angle color image.

Specifically, in step S106, because the coordinates of each point in a common-FOV image region whose field of view is common to the second field of view 300 of the current narrow-angle color image have been obtained, the CPU 3a extracts, from the current wide-angle monochrome image, the common-FOV image region.

For example, for the example illustrated in FIG. 3, the CPU 3a extracts, from the wide-angle monochrome image 60, the common-FOV image region 62 whose field of view is common to the second field of view 300 of the narrow-angle color image 70 in step S106.

Then, the CPU 3a calculates a disparity map including a disparity between each point, such as each pixel, in the extracted common-FOV image region and the corresponding point of the narrow-angle color image 70 using the stereo-matching in step S106.

Next, the CPU 3a calculates, relative to the stereo camera 2, an absolute distance to each point of the at least one common-FOV imaging subject located in the common-FOV image region in accordance with the disparity map.

Note that, if the size of the common-FOV image region extracted from the wide-angle monochrome image is larger than the size of the narrow-angle color image, the CPU 3a transforms the size of one of the common-FOV image region and the size of the narrow-angle color image to thereby match the size of the common-FOV image region with the size of the narrow-angle color image in step S106. Thereafter, the CPU 3a performs the stereo-matching based on the equally sized common-FOV image region and narrow-angle color image.

Next, in step S108, the CPU 3a corrects the scale of each feature point in the 3D shape of each of the imaging subjects derived in step S102 in accordance with the absolute distance to each point of the at least one common-FOV imaging subject derived in step S106.

Specifically, the absolute distance to each point of the at least one common-FOV imaging subject located in the common-FOV image region relative to the stereo camera 2 has been obtained based on the stereo-matching in step S106. Then, the CPU 3a calculates the relative positional relationships between the at least one common-FOV imaging subject and the at least one remaining imaging subject located at least partly outside the common-FOV image region. Thereafter, the CPU 3a calculates an absolute distance to each point of the at least one remaining imaging subject located outside the common-FOV image region in accordance with the absolute distance to each point of the at least one common-FOV imaging subject located in the common-FOV image region.

This enables the absolute distance to each point of each of the imaging subjects, which include the at least one common-FOV imaging subject located in the common-FOV image region and the at least one remaining imaging subject located outside the common-FOV image region, in the wide-angle monochrome image to be obtained.

Following the operation in step S108, the CPU 3a outputs, to the in-vehicle devices 50, the 3D shape of each of the imaging subjects derived in step S102, whose scale of each feature point in the 3D shape of the corresponding imaging subject has been corrected in step S108, as distance information about each of the imaging subjects located in the wide-angle monochrome image.

Next, the following describes the image recognition task carried out by the CPU 3a of the image processing unit 3 in a predetermined second control period, which can be equal to or different from the first control period.

In step S200 of a current cycle of the image recognition task, the CPU 3a fetches a wide-angle monochrome image captured by the monochrome camera 2a, and performs an object recognition process, such as pattern matching, to thereby recognize at least one specific target object. The at least one specific target object is included in the imaging subjects included in the wide-angle monochrome image.

For example, the memory device 3b stores an object model dictionary MD. The object model dictionary includes object models, i.e. feature quantity templates, provided for each of respective types of target objects, such as traffic movable objects, such as vehicles or pedestrians other than the vehicle 5, road traffic signs, and road markings, etc.

That is, the CPU 3a reads, from the memory device 3b, the feature quantity templates for each of the respective types of objects, and executes pattern matching processing between the feature quantity templates and the wide-angle monochrome image, thus recognizing the at least one specific target object based on the result of the pattern matching processing. That is, the CPU 3a obtains the at least one specific target object as a first recognition result.

Because the monochrome camera 2a is not provided with a color filter on the light receiving surface of the image sensor 22a1, the wide-angle monochrome image has higher resolution, so that the outline or profile of the at least one specific target object appears clearer. This enables the image recognition operation based on, for example, the pattern matching in step S200 to recognize the at least one specific target object with higher accuracy. In addition, because the monochrome camera 2a has the wider first horizontal view angle α, it is possible to detect specific target objects over a wider horizontal range in front of the vehicle 5.

In step S202, the CPU 3a fetches a narrow-angle color image that has been captured by the color camera 2b in synchronization with the current wide-angle monochrome image, from the color camera 2b, and loads the narrow-angle color image into the memory device 3b. In step S202, the CPU 3a recognizes a distribution of colors included in the narrow-angle color image.

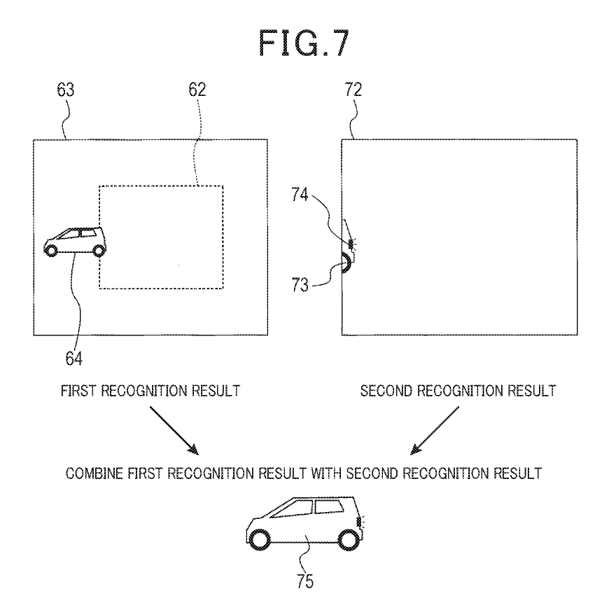

Next, in step S204, the CPU 3a performs a color recognition process in accordance with the distribution of colors included in the narrow-angle color image. Specifically, the CPU 3a extracts, from a peripheral region of the narrow-angle color image, at least one specific color region as a second recognition result in accordance with the distribution of colors included in the narrow-angle color image. The peripheral region of the narrow-angle color image represents a rectangular frame region having a predetermined number of pixels from each edge of the narrow-angle color image (see reference character RF in FIG. 7).

The at least one specific color region represents specific color, such as red, yellow, green, white, or other color; the specific color for example represents

(1) The color of at least one lamp or light of vehicles

(2) The color of at least one traffic light

(3) At least one color used by road traffic signs or

(4) At least one color used by road markings.

Next, in step S206, the CPU 3a integrates, i.e. combines, the second recognition result obtained in step S204 with the first recognition result obtained in step S200.

Specifically, in step S206, the CPU 3a combines the at least one color region with the at least one specific target object such that the at least one color region is replaced or overlapped with the corresponding region of the at least one specific target; the coordinates of the pixels constituting the at least one color region match with the coordinates of the pixels constituting the corresponding region of the at least one specific target.

Then, the CPU 3a outputs, to the in-vehicle devices 50, the combination of the second recognition result and the common-FOV image region as image recognition information in step S208.

The following describes an example of how the image recognition task is carried out with reference to FIG. 7. In FIG. 7, reference numeral 63 represents a wide-angle monochrome image, and reference numeral 72 represents a narrow-angle color image. In FIG. 7, reference numeral 62 represents a common-FOV image region having a field of view that is common to the second field of view 300 of the narrow-angle color image 70.

Hereinafter, let us assume that

(1) A vehicle to which reference numeral 64 is assigned is recognized in the wide-angle monochrome image 63 (see step S200)

(2) The most part of the vehicle 64 is distributed in the remaining image region of the wide-angle monochrome image 63 other than the common-FOV image region 62

(3) The remaining part, i.e. the rear end, of the vehicle 64 is located in the common-FOV image region 62

(4) A red region 74, which emits red light, is recognized in the left edge of the peripheral region RF (see step S202)

The red region 74 constitutes a part of the rear end 73 of the vehicle; the part appears in the left edge of the peripheral region RF. Unfortunately, executing an image recognition process based on, for example, pattern matching for the image of the rear end 73 appearing in the peripheral region RF of the narrow-angle color image 72 may not identify the red region 74 as a part of the vehicle. That is, it may be difficult to recognize that the red region 74 corresponds to a tail lamp of the vehicle using information obtained from only the narrow-angle color image 72.

From this viewpoint, the CPU 3a of the image processing unit 3 combines the red region 74 as the second recognition result with the vehicle 64 as the first recognition result such that the red region 74 is replaced or overlapped with the corresponding region of the vehicle 64; the coordinates of the pixels constituting the red region 74 match with the coordinates of the pixels constituting the corresponding region of the vehicle 64.

This enables the image recognition information representing the vehicle whose tail lamp is emitting red light to be obtained (see reference numeral 75).

### Advantageous Effect

The shape measuring apparatus 1 according to the present embodiment obtains the following advantageous effects.

The shape measuring apparatus 1 is configured to use a wide-angle monochrome image and a narrow-angle color image to thereby obtain distance information about at least one imaging subject included in the wide-angle monochrome image, and color information about the at least one imaging subject. In particular, the shape measuring apparatus 1 is configured to capture a monochrome image using the monochrome camera 2a having the relatively wide view angle α. This configuration enables a wide-angle monochrome image having higher resolution to be obtained, making it possible to improve the capability of the shape measuring apparatus 1 for recognizing a target object located at a relatively long distance from the shape mearing apparatus 1.

The shape measuring apparatus 1 is configured to derive, from sequential wide-angle monochrome images, the 3D shape of an imaging subject located in the common-FOV image region using, for example, a known SfM approach. This configuration enables the 3D shape of the imaging subject, which cannot be recognized by stereo-matching between a monochrome image and a color image, to be recognized. This configuration also enables the absolute scale of the imaging subject located in the common-FOV image region to be obtained based on the stereo-matching. This configuration also enables the 3D shape of at least one remaining imaging subject located outside the common-FOV image region to be obtained in accordance with the reference of the absolute scale of the imaging subject located in the common-FOV image region.

The shape measuring apparatus 1 is configured to change the exposure interval indicative of the interval between the end of the exposure of one horizontal line (row) to incident light and the start of the exposure of the next horizontal line to incident light for the wide-angle monochrome image 60 in the rolling shutter mode relative to the exposure interval indicative of the interval between the end of the exposure of one horizontal line to incident light and the start of the exposure of the next horizontal line to incident light for the narrow-angle color image 70 in the rolling shutter mode.

This configuration makes it possible to substantially synchronize the exposure period of the common-FOV image region of the wide-angle monochrome image with the exposure period of the whole of the narrow-angle color image.

The shape measuring apparatus 1 is configured to integrate, i.e. combine, the first recognition result based on the object recognition process for a wide-angle monochrome image with the second recognition result based on the color recognition process for a narrow-angle color image.

This configuration makes it possible to complement one of the first recognition result and the second recognition result with the other thereof.

The monochrome camera 2a corresponds to, for example, a first imaging device, and the color camera 2b corresponds to, for example, a second imaging device.

The functions of one element in the present embodiment can be distributed as plural elements, and the functions that plural elements have can be combined into one element. At least part of the structure of the present embodiment can be replaced with a known structure having the same function as the at least part of the structure of the present embodiment. A part of the structure of the present embodiment can be eliminated. All aspects included in the technological ideas specified by the language employed by the claims constitute embodiments of the present disclosure.

The present disclosure can be implemented by various embodiments; the various embodiments include systems each including the shape measuring apparatus 1, programs for serving a computer as the image processing unit 3 of the shape measuring apparatus 1, storage media, such as non-transitory media, storing the programs, and distance information acquiring methods.

While the illustrative embodiment of the present disclosure has been described herein, the present disclosure is not limited to the embodiment described herein, but includes any and all embodiments having modifications, omissions, combinations (e.g., of aspects across various embodiments), adaptations and/or alternations as would be appreciated by those having ordinary skill in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. A shape measuring apparatus comprising:
a first imaging device having a first field of view defined based on a first view angle, the first imaging device being configured to capture sequential monochrome images based on the first field of view;
a second imaging device having a second field of view defined based on a second view angle, the second imaging device being configured to capture a color image based on the second field of view, the second view angle being narrower than the first view angle, the first and second fields of view having a common field of view; and
an image processing unit configured to:
calculate a disparity between a common image region of a selected one of the monochrome images and the color image, the selected monochrome image being substantially synchronized with the color image, the common image region having a field of view that is common to the second field of view of the second imaging device, the imaging subjects including at least a first imaging subject located in the common image region and a second imaging subject located at least partly outside the common image region;
derive, based on the calculated disparity, absolute distance information about the first imaging target from the shape measuring apparatus; and
reconstruct a three-dimensional shape of each of the imaging subjects including the first and second imaging subjects based on the sequential monochrome images.

2. The shape measuring apparatus according to claim 1, wherein the image processing unit is configured to correct the three-dimensional shape of the second imaging subject in accordance with the absolute distance information about the first imaging target.

3. The shape measuring apparatus according to claim 2, wherein:
each of the first and second imaging devices comprises an image sensor that includes a light receiving area comprised of light-sensitive pixels arranged in horizontal rows and vertical columns,
the first imaging device being configured to drive the corresponding image sensor in a rolling shutter mode to thereby capture each of the sequential monochrome images,
the second imaging device being configured to drive the corresponding image sensor in the rolling shutter mode to thereby capture the color image; and
at least one of the first and second imaging devices is configured to change at least one of a first exposure interval and a second exposure interval relative to the other thereof in accordance with a ratio of the first view angle to the second view angle,
the first exposure interval representing an interval between an end of exposure of one horizontal row to incident light and a start of the exposure of a next horizontal row to incident light for each of the sequential monochrome images,
the second exposure interval representing an interval between an end of the exposure of one horizontal line to incident light and a start of the exposure of a next horizontal line to incident light for the color image,
changing of at least one of the first exposure interval and the second exposure interval relative to the other thereof resulting in substantial synchronization of an exposure period of the common image region of each of the sequential monochrome images with an exposure period of the color image.

4. The shape measuring apparatus according to claim 2, wherein the image processing unit is configured to:
recognize a specific target object in the selected one of the sequential monochrome images;
recognize at least one color image region in a peripheral region of the color image, the at least one color image region representing a specific color; and
combine information about the at least one color image region with information about a predetermined region in the specific target, the predetermined region in the specific target in the selected one of the sequential monochrome images corresponding to the at least one color image region.

5. A shape measuring method comprising:
capturing, using a first imaging device having a first field of view defined based on a first view angle, sequential monochrome images based on the first field of view;
capturing, using a second imaging device having a second field of view defined based on a second view angle, α color image based on the second field of view, the second view angle being narrower than the first view angle, the first and second fields of view having a common field of view;
calculating a disparity between a common image region of a selected one of the monochrome images and the color image, the selected monochrome image being substantially synchronized with the color image, the common image region having a field of view that is common to the second field of view of the second imaging device, the imaging subjects including at least a first imaging subject located in the common image region and a second imaging subject located at least partly outside the common image region;
deriving, based on the calculated disparity, absolute distance information about the first imaging target from a predetermined reference point; and
reconstructing a three-dimensional shape of each of the imaging subjects including the first and second imaging subjects based on the sequential monochrome images.

6. The shape measuring method according to claim 5, further comprising:
correcting the three-dimensional shape of the second imaging subject in accordance with the absolute distance information about the first imaging target.

7. The shape measuring method according to claim 6, wherein:
each of the first and second imaging devices comprises an image sensor that includes a light receiving area comprised of light-sensitive pixels arranged in horizontal rows and vertical columns,
the capturing step using the first imaging device drives the corresponding image sensor in a rolling shutter mode to thereby capture each of the sequential monochrome images; and
the capturing step using the second imaging device drives the corresponding image sensor in the rolling shutter mode to thereby capture the color image,
the shape measuring method further comprising:
changing, using at least one of the first and second imaging devices, at least one of a first exposure interval and a second exposure interval relative to the other thereof in accordance with a ratio of the first view angle to the second view angle,
the first exposure interval representing an interval between an end of exposure of one horizontal row to incident light and a start of the exposure of a next horizontal row to incident light for each of the sequential monochrome images,
the second exposure interval representing an interval between an end of the exposure of one horizontal line to incident light and a start of the exposure of a next horizontal line to incident light for the color image,
changing of at least one of the first exposure interval and the second exposure interval relative to the other thereof resulting in substantial synchronization of an exposure period of the common image region of each of the sequential monochrome images with an exposure period of the color image.

8. The shape measuring method according to claim 6, further comprising:
recognizing a specific target object in the selected one of the sequential monochrome images;
recognizing at least one color image region in a peripheral region of the color image, the at least one color image region representing a specific color; and
combining information about the at least one color image region with information about a predetermined region in the specific target, the predetermined region in the specific target in the selected one of the sequential monochrome images corresponding to the at least one color image region.
